(19) United States
(12) Patent Application Publication
(10) Pub. No.: US 2007/0288749 A1
(43) Pub. Date: Dec. 13, 2007

(54) Unscrambled channel detection system and method

(75) Inventor: Janghwan Lee, Pleasanton, CA (US)

Correspondence Address: FLETCHER YODER, P.O. BOX 692289, HOUSTON, TX, 77269-2289, US

(73) Assignee: Shenzhen TCL New Technology LTD

(21) Appl. No.: 11/811,308

(22) Filed: Jun. 7, 2007

Related U.S. Application Data
(60) Provisional application No. 60/811,507, filed on Jun. 8, 2006.

(51) Int. Cl. H04L 9/00

(52) U.S. Cl. 713/160

(57) ABSTRACT

An exemplary method of controlling the operation of an electronic device based on an encryption status of a channel as encrypted or unencrypted comprises receiving a packet of data corresponding to the channel. The exemplary method further comprises determining whether the packet of data is encrypted, identifying the encryption status of the channel as encrypted if the packet of data is encrypted, incrementing an unencrypted packet count if the packet of data is not encrypted, identifying the encryption status of the channel as not encrypted if the unencrypted packet count exceeds a threshold value, and controlling the operation of an electronic device based on the encryption status of the channel.

### CROSS REFERENCE TO RELATED APPLICATION

This application claims priority based on U.S. Provisional Application Ser. No. 60/811,507 filed on Jun. 7, 2006, which is incorporated by reference as though completely set forth herein.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

One method of detecting encrypted packet streams employs a timer. In one example, the timer is used to check if encrypted packets for a particular program have been detected within a predefined time. If encrypted packets are detected, it is assumed that decryption will be needed for a time period at least as long as the length of time for which the timer is set. After expiration of the timer, the system may stop decryption until encrypted packets are again detected.

There is no definition of how many transport packets will be encrypted for a scrambled program, so it may be desirable to differentiate scrambled programs (which need decryption) from unscrambled programs (for which no decryption is needed. A potential problem with using timers is that it cannot be presumed how soon new encrypted packets for a given channel may arrive. Further, it is not possible to tell how many packets will be received in a predefined time because the data input rate of each transport packet stream can be varied.

### BRIEF DESCRIPTION OF THE DRAWINGS

In the drawings:

FIG. 1 is a block diagram of an electronic device in accordance with an exemplary embodiment of the present invention;

FIG. 2 is a process flow diagram showing the detection of encrypted pid data in accordance with an exemplary embodiment of the present invention;

FIG. 3 is a process flow diagram showing an initialization routine for pid monitoring in accordance with an exemplary embodiment of the present invention; and

FIG. 4 is a process flow diagram showing a timer routine for use in pid monitoring in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention relates to a way to detect scrambled channels by detecting unscrambled packets. By detecting the number of consecutive, unencrypted transport packets greater than a predefined number for a pid (packet identification), it can be determined whether a transport packet stream is unencrypted. An exemplary embodiment of the present invention counts the number of consecutive unencrypted packets and detects unencrypted programs from the data channel based on this information.

In a decryption system, a descrambler block decrypts the encrypted data such as video, audio and data with a decryption key. The encrypting information can be found using transport_scrambling_control bits in the transport stream packet and PES_scrambling_control bit in a packetized elementary stream (PES) packet. During the channel search procedure, each channel can be marked as having an encryption status of encrypted or unencrypted by the descrambler block using this information. A problem exists, however, in that it is not known when an encrypted packet for a chosen pid (packet identification) corresponding to a channel will be received. In some cases, there might be problems for low bit rate video or audio data case, where there may not be an encrypted PES packet for those pids, so the timer needs to have a longer period to cover these cases, and it will take a longer time for a channel search application to cover the channels.

An exemplary embodiment of the present invention may save some time to make a channel map based on a channel search using an exemplary embodiment of the present invention. A channel can be defined as encrypted whenever an encrypted packet arrives, so that channel stops monitoring and reports an encrypted program for that pid. During channel search, all pids for all subprograms for a transport stream are monitored, but the hardware may have a limitation for simultaneous monitoring for pids. For example, hardware usually supports the monitoring of 16-32 pids simultaneously, and channel search monitors pids for PAT, PMT, MGT, etc. as its default. In an exemplary embodiment of the present invention, the system does not need to wait until every pid packet is detected, and new monitoring for another subprogram can be started as soon as one pid being monitored is detected to have an encrypted pid and the hardware monitoring resource becomes available.

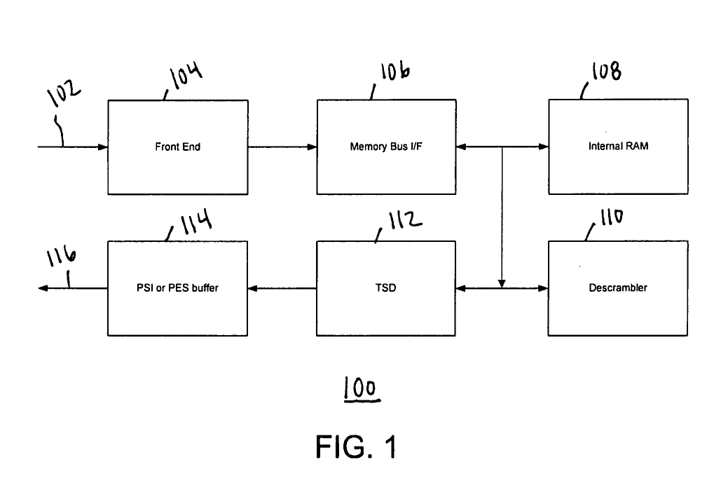

FIG. 1 is a block diagram of an electronic device in accordance with an exemplary embodiment of the present invention. The electronic device is generally referred to by the reference number 100. The electronic device 100 generally shows the basic block diagram around a descrambler unit constructed in accordance with an exemplary embodiment of the present invention. Those of ordinary skill in the art will appreciate that the various functional blocks shown in FIG. 1 may comprise hardware elements (including circuitry), software elements (including computer code stored on a machine-readatle medium) or a combination of both hardware and software elements.

The electronic device 100 is adapted to receive an input signal 102 via a front end block 104. The front end block may comprise an antenna and tuner, a video input or the like. The front end block 104 delivers data corresponding to the input signal 102 to a memory bus I/F block 106, which is adapted to provide data to an internal RAM block 108 that is shared by a descrambler block 110 and a transport stream demultiplexer block 112.

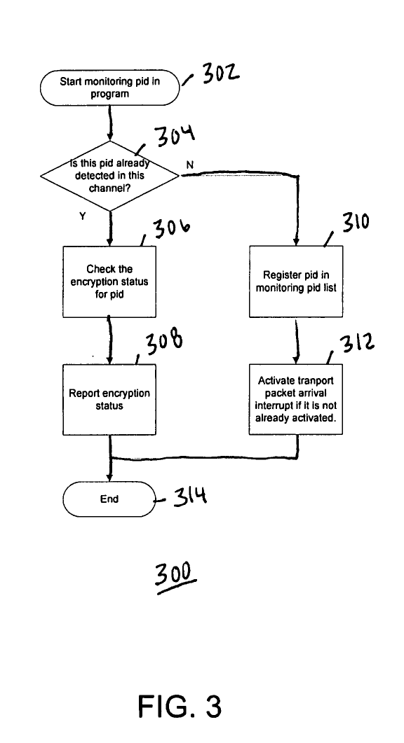

In an exemplary embodiment of the present invention, data is decrypted by the descrambler block 110 before it is accessed by the TSD block 112. This means that the TSD block would not access encrypted PES data if the descrambler block 110 is working properly to decrypt data. As set forth below with reference to FIG. 3, the presence of PES_scrambling_control bits in data accessed by the TSD block 112 would indicate that the descrambler block 110 is not working properly because those bits would be removed by the descrambler by the descrambler block 110 if it was working properly).

After processing by the TSD block 112, the data is delivered to a PSI or PES buffer 114. The data is subsequently transferred from the PSI or PES buffer 114 as an output data signal 116.

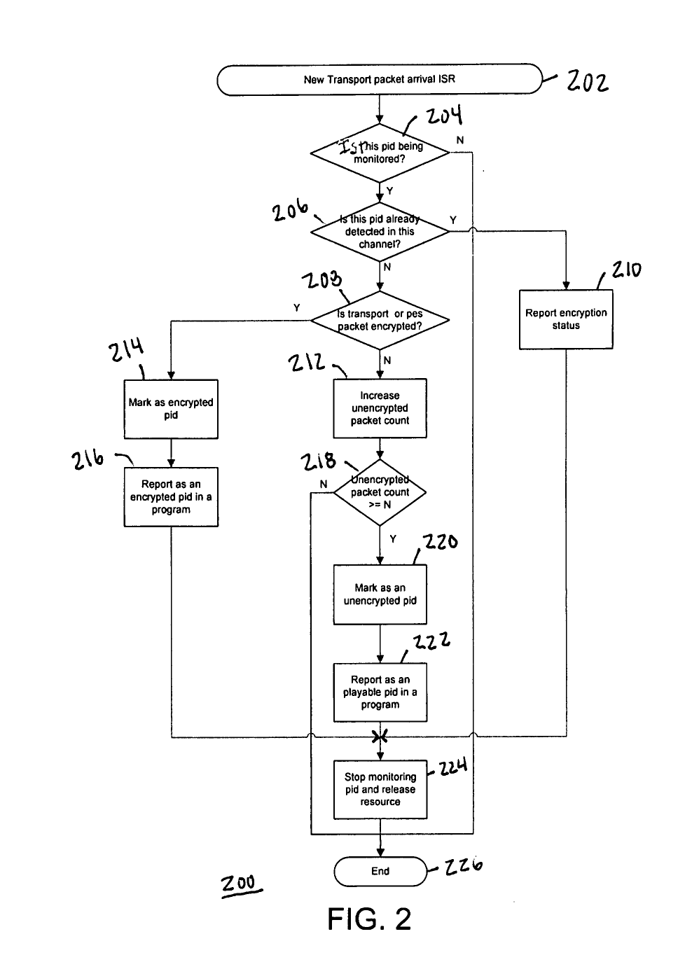

FIG. 2 is a process flow diagram showing the detection of encrypted pid data in accordance with an exemplary embodiment of the present invention. The process, which is generally referred to by the reference number 200, shows the operation of a transport packet arrival interrupt routine. The detection of encrypted data is reported to a channel search application and monitoring resources are promptly released in order to give the next pid a chance to be monitored for the same program or another subprogram. The process illustrated in FIG. 2 counts consecutive unencrypted packets, and, for detected unencrypted packets, it waits until it reaches the predefined number N. It decides the pid is playable and not encrypted if it counts N consecutive unencrypted packets. By counting unencrypted packets for a pid, the likelihood of detecting an unencrypted pid is improved. Those of ordinary skill in the art will be able to determine an appropriate value for N based on system design considerations without undue experimentation.

At block 202, the process begins with the arrival of a new transport packet. A determination about whether a particular pid is being monitored is made at block 204. If the particular pid is not being monitored, the process ends at block 226 until the arrival of a new packet.

If the particular pid is being monitored at block 204, a determination is made about whether the particular pid has already been detected for the corresponding channel at block 206. If the pid has been previously detected, its status as encrypted or not is already known. That status is reported to the channel search application at block 210. At block 224, the monitoring of the particular pid is stopped and the monitoring resources are released so that they may be used to monitor another pid. At block 226, the process ends until the arrival of a new packet.

If the particular pid has not been previously detected at block 206, a determination is made about whether the associated transport stream or PES packet is encrypted at block 208. If the transport stream or PES packet is encrypted, the pid is marked as encrypted at block 214 and the pid is reported to the channel search application as being encrypted at block 216. At block 224, the monitoring of the particular pid is stopped and the monitoring resources are released so that they may be used to monitor another pid. At block 226, the process ends until the arrival of a new packet.

If the transport or PES packet is determined to be not encrypted at block 208, an unencrypted packet counter is incremented at block 212. At block 218, a determination is made about whether the number of unencrypted packets measured by the unencrypted packet counter exceeds a predetermined number N at block 218. If the number of unencrypted packets does not exceed the predetermined number N, the process ends at block 226 until the arrival of a new packet.

If the number of unencrypted packets exceeds the predetermined number N at block 218, the current pid is marked at block 220 and the pid is reported as playable to the channel search application. At block 224, the monitoring of the particular pid is stopped and the monitoring resources are released so that they may be used to monitor another pid. At block 226, the process ends until the arrival of a new packet.

In an exemplary embodiment of the present invention, the process shown in FIG. 2 is applied to the normal operation for each sub-channel. In this manner, an encryption state update may be detected.

FIG. 3 is a process flow diagram showing an initialization routine for pid monitoring in accordance with an exemplary embodiment of the present invention. The process is generally referred to by the reference number 300. At block 302, the process begins.

At block 304, a determination is made about whether the current pid has already been detected for a given channel. If the pid has already been detected, the encryption status for the pid is already known and that status is checked at block 306. At block 308, the previously-determined encryption status of the pid is reported to the channel search application at block 308 and the process ends at block 314.

If the pid has not been previously detected at block 304, the pid is registered in a monitoring list at block 310. A transport packet arrival interrupt, which may be used to invoke a process such as the process shown in FIG. 2, is invoked at block 312 if the interrupt is not already activated. The process ends at block 314.

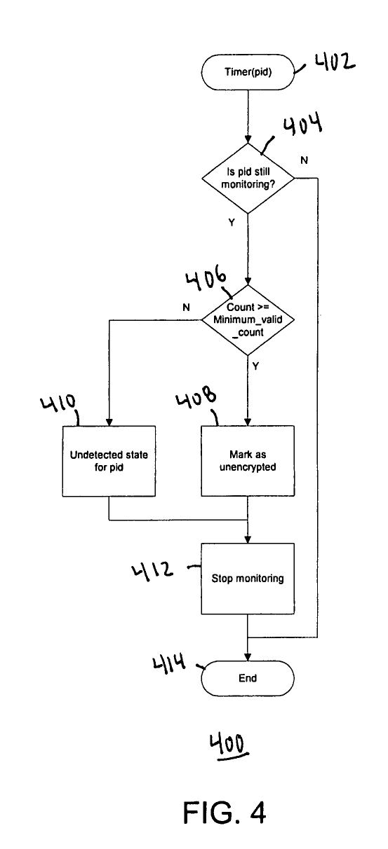

FIG. 4 is a process flow diagram showing a timer routine for use in pid monitoring in accordance with an exemplary embodiment of the present invention. The process is generally referred to by the reference number 400. At block 402, the process begins.

At block 404, a determination is made about whether a pid is still being monitored. If the pid is no longer being monitored, the process ends at block 414.

If the pid is still being monitored at block 404, a determination is made about whether a count is greater than or equal to a minimum valid count at block 406. If the count is not greater than the minimum valid count, the pid is identified as being in an undetected state at block 410 and monitoring stops at block 412. The process ends at block 414.

If the count is determined to be greater than or equal to the minimum valid count at block 406, the pid is marked as unencrypted at block 408. Monitoring stops at block 412 and the process ends at block 414.

The exemplary timer routine shown in FIG. 4 may be employed for each pid monitor. The timer routine may stop when the exemplary process illustrated in FIG. 2 releases resources, so that the timer will be used for undetected cases only. It makes a decision on the counts of received unencrypted packets. Even if the unencrypted packet does not meet the criteria shown in the exemplary process illustrated in FIG. 2, the process of FIG. 4 compares the detected number of unencrypted packets with a predefined minium_valid_count for the case of a very slow data rate. For instance, a pid may be determined to be unencrypted if there are five (5) consecutive unencrypted packets within the predefined time (e.g. before the expiration of the timer routine illustrated in FIG. 4). In that case, the minimum_valid_count is five (5).

An exemplary embodiment of the present invention can detect an encrypted program for a very low bit rate. Also, an exemplary embodiment of the invention may detect any case, and it detects encrypted and unencrypted programs quicker with fewer hardware resources relative to prior art systems.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of controlling the operation of an electronic device based on an encryption status of a channel as encrypted or unencrypted, the method comprising:
receiving a packet of data corresponding to the channel;
determining whether the packet of data is encrypted;
identifying the encryption status of the channel as encrypted if the packet of data is encrypted;
incrementing an unencrypted packet count if the packet of data is not encrypted;
identifying the encryption status of the channel as not encrypted if the unencrypted packet count exceeds a threshold value; and
controlling the operation of an electronic device based on the encryption status of the channel.

2. The method recited in claim 1, comprising reporting the encryption status of the channel to a channel search application.

3. The method recited in claim 1, comprising determining whether the encryption status of the channel has previously been determined.

4. The method recited in claim 3, comprising assigning the previously-determined encryption status to the channel.

5. The method recited in claim 3, comprising registering the channel in a list of monitored channels if the encryption status of the channel has not been previously been determined.

6. The method recited in claim 3, comprising activating a transport packet arrival interrupt if the encryption status of the channel has not been previously been determined.

7. The method recited in claim 1, comprising releasing a monitoring resource associated with the channel upon determining the encryption status of the channel.

8. The method recited in claim 1, comprising determining whether the unencrypted packet count exceeds the threshold value.

9. The method recited in claim 1, wherein the recited acts are performed in the recited order.

10. An electronic device, comprising
a front end that is adapted to receive data corresponding to a channel; and
a descrambler that is adapted to:
receive a packet of data corresponding to the channel;
determine whether the packet of data is encrypted;
identify an encryption status of the channel as encrypted if the packet of data is encrypted;
increment an unencrypted packet count if the packet of data is not encrypted; and
identify the encryption status of the channel as not encrypted if the unencrypted packet count exceeds a threshold value.

11. The electronic device recited in claim 10, wherein the descrambler is adapted to report the encryption status of the channel to a channel search application.

12. The electronic device recited in claim 10, wherein the descrambler is adapted to determine whether the encryption status of the channel has previously been determined.

13. The electronic device recited in claim 12, wherein the descrambler is adapted to assign the previously-determined encryption status to the channel.

14. The electronic device recited in claim 12, wherein the descrambler is adapted to register the channel in a list of monitored channels if the encryption status of the channel has not been previously been determined.

15. The electronic device recited in claim 12, wherein the descrambler is adapted to activate a transport packet arrival interrupt if the encryption status of the channel has not been previously been determined.

16. The electronic device recited in claim 10, wherein the descrambler is adapted to release a monitoring resource associated with the channel upon determining the encryption status of the channel.

17. The electronic device recited in claim 10, wherein the descrambler is adapted to determine whether the unencrypted packet count exceeds the threshold value.

18. An electronic device, comprising:
means for receiving a packet of data corresponding to a channel;
means for determining whether the packet of data is encrypted;
means for identifying an encryption status of the channel as encrypted if the packet of data is encrypted;
means for incrementing an unencrypted packet count if the packet of data is not encrypted; and
means for identifying the encryption status of the channel as not encrypted if the unencrypted packet count exceeds a threshold value.

19. The electronic device recited in claim 18, comprising means for reporting the encryption status of the channel to a channel search application.

20. The electronic device recited in claim 18, comprising means for determining whether the encryption status of the channel has previously been determined.
